(19) United States
(12) Patent Application Publication
(10) Pub. No.: US 2023/0223766 A1
(43) Pub. Date: Jul. 13, 2023

(54) BATTERY CELL BALANCING CIRCUIT SYSTEM AND METHOD

(71) Applicant: Neutron Automotive Controls Inc., Ottawa (CA)

(72) Inventors: Alexandre GOURARI, Toronto (CA); John Joseph WOJTKOWICZ, Yarker (CA); David STUBBS, Ottawa (CA)

(21) Appl. No.: 17/891,751

(22) Filed: Aug. 19, 2022

Related U.S. Application Data
(60) Provisional application No. 63/234,920, filed on Aug. 19, 2021.

(51) Int. Cl. H02J 7/00; H01M 10/61

(52) U.S. Cl. CPC H02J 7/0019; H01M 10/61; H02J 7/0048; H01M 2220/20

(57) ABSTRACT

Battery cells and other types of energy cells are not produced identically, and the performance and degradation of the cells vary over time. This makes it challenging to balance and manage stacks of cells arranged in series. A battery circuit is provided that includes each cell having an inline switch that is in series with the respective cell, and an outline switch that is parallel to the respective cell and the inline switch. When the inline switch is open and the corresponding outline switch is closed, the respective cell is electrically isolated from the stack. Specific cells within a stack can be electrically isolated to vary power, balance the circuit, remove damaged cells, and provide rest to the cells to extend the lifetime usage of the cells.

### CROSS REFERENCE TO RELATED APPLICATIONS

This application claims priority to U.S. Provisional Patent Application No. 63/234,920, filed on Aug. 19, 2021, and titled “Battery Cell Balancing Circuit System And Method”, the entire contents of which are herein incorporated by reference.

### TECHNICAL FIELD

The following generally relates to battery cell balancing circuit systems and related methods.

### DESCRIPTION OF THE RELATED ART

Battery cells are used to store electric energy and provide electric energy in many different applications. For example, vehicles such as trucks, buses, cars, marine vehicles, and, aircraft, are becoming more electrically driven. Electric motors are being used as primary drivers or secondary drivers for motive force instead of combustion engines. This requires a larger battery system to provide electrical power. Larger battery systems typically include many battery cells that are connected to provide the current draw and voltage levels used by motors and other electrical devices (e.g., heating, cooling, braking, actuators, etc.). Battery management systems are used to manage the large number of batteries. These battery management systems are also used in power or utility grids, such as for power generators, power banks, buildings, and facilities.

A set of battery cells are typically placed in series to form a battery stack. Many stacks of batteries are typically combined to form a battery bank. Battery stacks can be combined in parallel, or in serial, or both. A battery bank could have dozens of battery cells, or even thousands of cells. Some electric cars, for example, have over seven thousand cells.

Ideally, battery cells within a system charge and discharge at the same rate and experience the same operating parameters. It is herein recognized, however, that battery cells are not identical and, therefore, performance and degradation vary from one cell to another. For example, variance in battery chemistry affect how fast a given battery cell will charge or discharge. Furthermore, the amount of charge a given battery cell can hold will vary from other battery cells in the same system.

The differences in charging rate and discharging rate between battery cells in the same stack affects the overall performance of the stack. This can make controlling power usage (e.g., discharging the battery system) or controlling power storage (e.g., charging the battery system) difficult to control and inefficient. For example, a single cell that has been drained in a stack can render the stack unusable if there is no balancing mechanism.

Existing battery balancing systems adjust for the differences in the battery cells in different ways.

For example, an existing approach is to balance battery cells in a stack is called passive balancing. A given a cell in a battery stack is selected as the reference cell, and it is typically the lowest performing cell (e.g., the cell that charges the slowest, or the cell that discharges the fastest, or the lowest energy capacity cell). The other cells in the same stack are 1discharged through a resistor, also called “bleeding off”, to match the lower performing cell. U.S. Pat. No. 6,114,835 to Price (the '835 patent) describes a charge balancing circuit that determines a charge balancing refence cell from among the cells that have not crossed a voltage threshold after a current time. For example, this reference cell charges too slowly compared to the other cells. The charge balancing circuit modifies the charges of the other cells in the stack until their voltage levels are equal to the reference cell. As shown in FIG. 1A, an example equalization circuit representing an aspect from the '835 patent shows a stack 103 of battery cells, and a switch 100 is connected to each cell 101 to divert power away from the cell. The switch 100 is closed to discharge or dissipate current from a given cell 101 current through a correspondingly connected resistor 102.

This approach of voltage matching is also used in larger battery systems with parallel battery stacks. U.S. Pat. No. 8,598,847 to Eberhard et al. (the '847 patent) describes parallel battery stacks and charging the battery stacks so that the lowest voltage the parallel battery stacks is kept constant, and the energy of other battery stacks is dissipated to match the battery stack with the lowest voltage. FIG. 1B shows a stack of cells 101 representing an aspect in the '847 patent, and it uses switches 100 and discharge resistors 102 connected to each cell, and a given switch is used control the discharge of the energy through a corresponding given discharge resistor.

Another example of passive cell balancing control is shown in U.S. Patent Application Publication No. 2011/0109269 A1 to Li (the '269 application), which uses resistors to bleed of energy from a cell. The controls of the shunt paths in the '269 application is based on voltages of neighboring cells. See FIG. 10 representing an aspect of the '269 application, which shows a circuit that responds to an unbalanced condition of CELL1 by having the controller conducting the current path to generate a current flowing through the current path according to a total voltage of CELL1 and CELL2. The controller turns on the switch 110 and the switch 120 simultaneously. The current generated based on the total voltage of CELL1 and CELL2 flows through the resistor 118 to produce a voltage drop across the resistor 118. Therefore, even if the voltage of CELL1 is relatively low, the voltage drop across the resistor 118 can still be large enough to turn on the bleeding control switch 116. When the bleeding control switch is activated, a shunt path is formed by the resistor 114 and switch 116 in parallel with CELL1. A similar control process occurs if the voltage of CELL2 becomes unbalanced, and a voltage drop across the resistor 112 can be large enough to turn on the bleeding control switch 106 to form the shunt path, which includes the resistor 104 and the bleeding control switch 106 in parallel to CELL2.

Matching cell voltages to a reference cell (e.g., typically a lower performance cell) by using passive balancing is inefficient and lowers the overall performance of the battery stack. For example, many equalization circuits divert or discharge power from other higher performing cells in the stack, which is a waste of electrical power. The bleeding off process also leads to extra heat production, which limits the overall balancing performance. For example, dumping or bleeding too much current too quickly will overheat the resistors. In battery charging applications, passive cell balancing is considered slow. Furthermore, the overall performance of the stack is matched to the lower performing battery cell.

Another existing approach is active balancing, which includes using a capacitor to store energy and redistribute the energy to other cells. U.S. Patent Application Publication No. 2007/0257642 A1 to Xiao et al. (the '642 application) describes a system, a representation of an aspect which is shown in FIG. 1D. As shown in FIG. 1D, a charge shuttling circuit 142 includes an energy storage element, such as a capacitor. Other storage elements include a transformer or inductor. The processor 152 and cell balancer 151 direct charge shuttling among cells 132-1, 132-2, 132-3, 132-4 in the stack 132 by controlling switches 150 to direct charges from one or more of the cells with the higher voltage to be temporarily stored in the capacitor 142. Such charges are then shuttled to a lower voltage cell by the appropriate switches 150 of the switch network. The circuit also includes several bleeding circuits 140-1, 140-2, 140-3, 140-4 to bleed the current of each cell. In other words, the '642 application describes a hybrid of both active balancing by shuttling charges from higher voltage cells to lower voltage cells, and by passively balancing the cells by bleeding the cells with the higher voltage levels.

While active balancing does not waste as much energy compared to passive balancing, the use of capacitors, inductors, or transformers, is very slow. There are also electromagnetic compatibility (EMC) concerns when using these types of energy storage elements, since switching power may cause electromagnetic interference issues to these energy storage elements. Furthermore, the energy storage elements must be larger to transfer more energy more quickly. However, the larger these energy storage elements, the heavier and more space these components take, which may not be feasible for weight and space constrained applications (e.g., cars, airplanes, robotic platforms, mobile or semi-mobile power banks, etc.). Furthermore, energy storage elements are very expensive, comparative to resistors used in passive balancing.

It is herein recognized that it is desirable to provide a more energy efficient battery balancing system. More generally, it is herein recognized that it is desirable to provide a battery balancing system that addresses one or more of the drawbacks of the above-noted existing balancing systems.

### BRIEF DESCRIPTION OF THE DRAWINGS

Embodiments will now be described by way of example only with reference to the appended drawings wherein:

FIG. 1A is a schematic diagram of an existing passive battery balancing system, representing an aspect of U.S. Pat. No. 6,114,835.

FIG. 1B is a schematic diagram of another existing passive battery balancing system, representing an aspect of U.S. Pat. No. 8,598,947.

FIG. 1C is a schematic diagram of another existing passive battery balancing system, representing an aspect of U.S. Patent Application Publication No. 2011/0109269.

FIG. 1D is a schematic diagram of an existing active battery balancing system that also includes a passive balancing system, representing an aspect of U.S. Patent Application Publication No. 2007/0257642.

FIG. 2A is a schematic diagram of a battery balancing system under load, according to an example embodiment.

FIG. 2B is schematic diagram of another example embodiment of a battery balancing system under load, wherein a given inline switch is in series with a different terminal of a corresponding battery compared to the example embodiment of FIG. 2A.

FIG. 2C is a schematic diagram of a battery balancing system under charge, according to an example embodiment.

FIG. 3 is a schematic diagram of a battery balancing system including battery monitoring system, according to an example embodiment.

FIG. 4 is a schematic diagram of a battery balancing system including multiple battery stacks, according to an example embodiment.

FIG. 5 is a flow diagram of processor executable instructions for controlling a battery balancing system while charging, according to an example embodiment.

FIG. 6 is a flow diagram of processor executable instructions for controlling a battery balancing system while under load or discharging, according to an example embodiment.

FIG. 7 is a schematic of a database that stores cell data used to determine control of the cells, according to an example embodiment.

FIG. 8 is a flow diagram of processor executable instructions for permanently disconnecting a cell from a stack.

FIG. 9 is a flow diagram of processor executable instructions for individually testing cells within a stack, according to an example embodiment.

FIG. 10 is a flow diagram of processor executable instructions for isolating one or more cells within a stack at different times and repeatedly, according to an example embodiment.

FIG. 11 is a schematic diagram of a fuel cell balancing system including a fuel cell monitoring system, according to an example embodiment.

FIG. 12 is a schematic of an electric vehicle that includes a battery balancing system, according to an example embodiment.

FIG. 13 is a schematic of a power bank that includes a battery balancing system, according to an example embodiment.

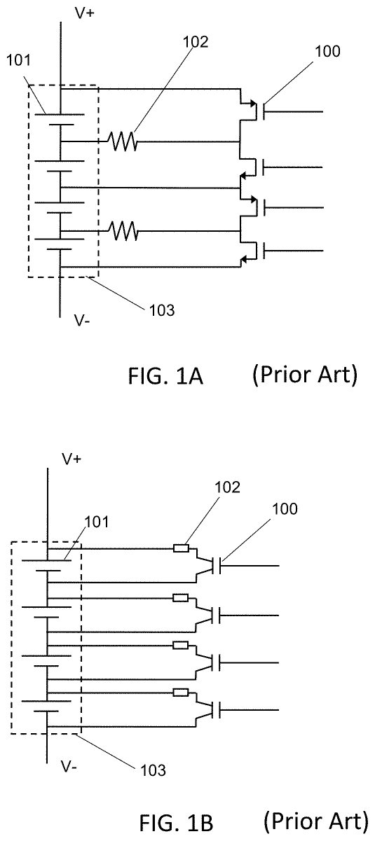

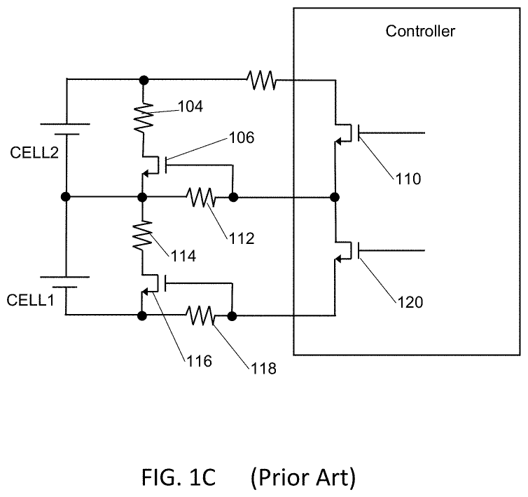

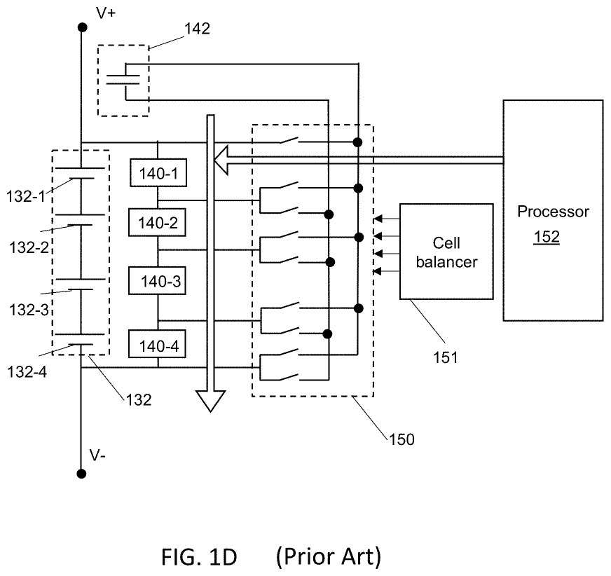

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this specification, numerous specific details have been set forth. It is to be understood, however, that implementations of the disclosed technology may be practiced without these specific details. In other instances, well-known methods, structures, and techniques have not been shown in detail in order not to obscure an understanding of this description. References to “for example”, “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

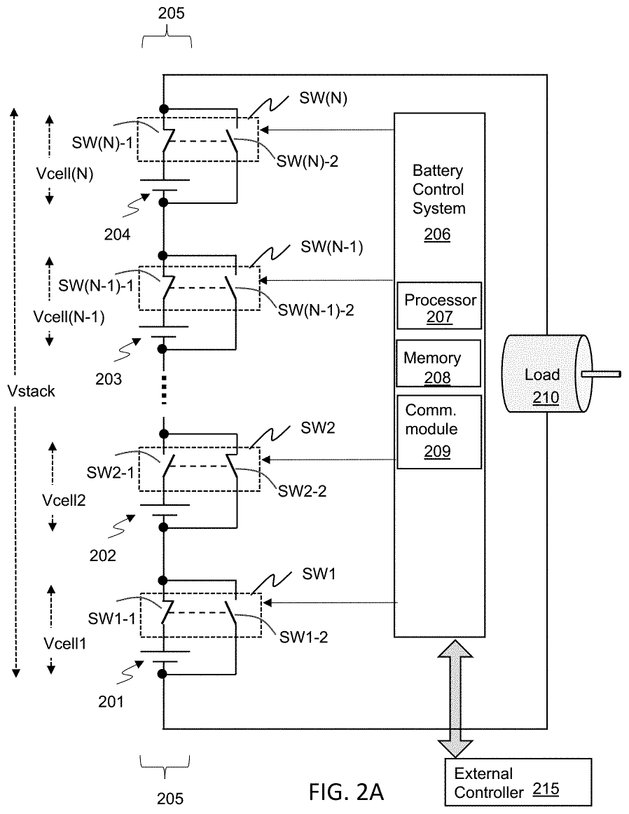

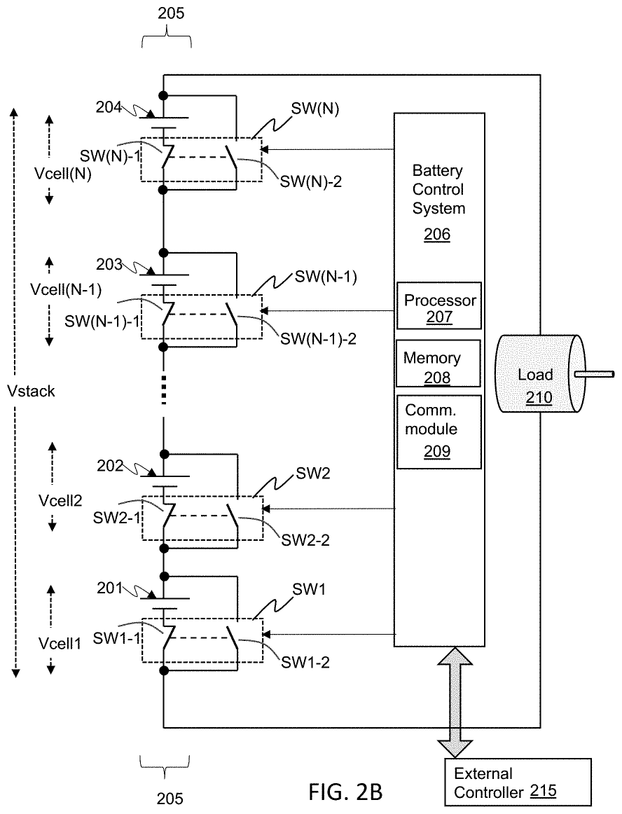

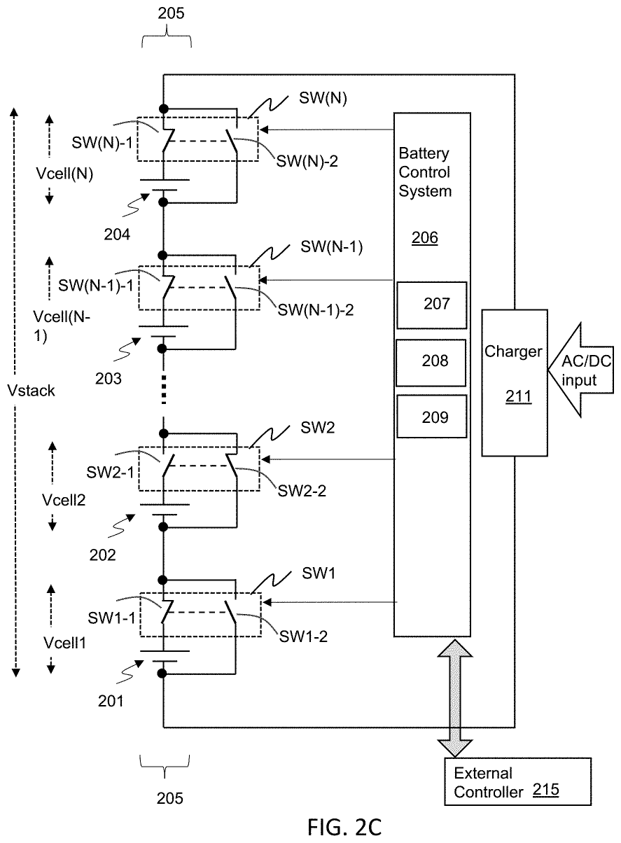

In an example embodiment, an extremely efficient battery balancing system is provided. Turning to FIG. 2A, a stack 205 of battery cells 201, 202, 203, 304 are provided and are connected to each other in series. Each cell is electrically connected to an inline switch and an outline switch. The inline switch is connected to a given cell in series, and the outline switch is connected to the same given cell and the inline switch in parallel.

For example, the cell 201 is connected to an inline switch SW1-1 in series. The inline switch SW1-1 is inline with the electrical path of the stack 205 and is connected in series to the other cells, including the neighboring series connected cell 202. An outline switch SW1-2 is connected in parallel to both the inline switch SW1-1 and the cell 201. In an example embodiment, the switches SW1-1 and SW1-2 operate in a coordinated manner, so that when one switch is closed, then the other corresponding switch is open. For example, when the inline switch SW1-1 is closed, then the outline switch SW1-2 is open. Conversely, when the inline switch SW1-1 is open, then the outline switch SW1-2 is closed. The switches are controlled by a battery control system 206.

The cell 201 can be connected into the stack or it can be isolated from the stack. The battery control system 206 connects the cell 201 to the stack by controlling the inline switch SW1-1 to be closed and controlling the outline switch SW1-2 to be open. The battery control system isolates the cell 201 from the stack by controlling the inline switch SW1-1 to be open and controlling the outline switch SW1-2 to be closed.

It will be appreciated that while the cell 201 (or any other cell or cells in the stack) is isolated, the one or more other cells in the stack can remain connected in series to the stack.

For example, a cell 201 has a first terminal and a second terminal, which are electrical connections. A cell 202 has a first terminal and a second terminal, and the first terminal is in electrical communication with the second terminal of cell 201. A cell 203 also has a first terminal and a second terminal, and the first terminal is in electrical communication with a second terminal of a neighboring cell (e.g., the second terminal of cell 202 assuming no intervening cells). A cell 204, also called the Nth cell, has a first terminal and a second terminal, and the first terminal is connected to the second terminal of the cell 203. In other words, the N cells form a stack of cells in series, where N is integer.

In the example shown in FIG. 2A, a switch SW1-1 has a first terminal and a second terminal. The first terminal of the inline switch SW1-1 is connected to the second terminal of the cell 201 and the second terminal of the switch SW1-1 is connected to a first terminal of the cell 202. In other words, the inline switch SW1-1 is in series between the cell 201 and the cell 202. A parallel loop has a first terminal and a second terminal connected to the stack. In particular, the parallel loop's first terminal is connected to the first terminal of the cell 201, and the parallel loop's second terminal is connected to the inline switch's SW1-1 second terminal. On the parallel loop is the outline switch SW1-2 that is controlled in an opposite manner to the inline switch SW1-1. In other words, when SW1-2 is closed, then SW1-1 is open; and when SW1-2 is open, then SW1-1 is closed.

In relation to the second cell 202, the inline switch SW2-1 has a first terminal and a second terminal. The first terminal of the inline switch SW2-1 is connected to the second terminal of the cell 202 and the second terminal of the switch SW2-1 is connected to a first terminal of the next neighboring cell, for example cell 203 assuming there are no intervening cells. In other words, the switch SW2-1 is in series between the cell 202 and the cell 203. A parallel loop corresponding to cell 202 has a first terminal and a second terminal connected to the stack. In particular, the parallel loop's first terminal is connected to the first terminal of the cell 202, and the parallel loop's second terminal is connected to the inline switch's SW2-1 second terminal. On the parallel loop is the outline switch SW2-2 that is controlled in an opposite manner to the inline switch SW2-1. In other words, when SW2-2 is closed, then SW2-1 is open; and when SW2-2 is open, then SW2-1 is closed.

In relation to the cell 203, the inline switch SW(N−1)-1 has a first terminal and a second terminal. The first terminal of the inline switch SW(N−1)-1 is connected to the second terminal of the cell 203 and the second terminal of the switch SW(N−1)-1 is connected to a first terminal of the next neighboring cell, for example cell 204. In other words, the switch SW(N−1)-1 is in series between the cell 203 and the cell 204. A parallel loop corresponding to cell 203 has a first terminal and a second terminal connected to the stack. In particular, the parallel loop's first terminal is connected to the first terminal of the cell 203, and the parallel loop's second terminal is connected to the inline switch's SW(N−1)-1 second terminal. On the parallel loop is the outline switch SW(N−1)-2 that is controlled in an opposite manner to the inline switch SW(N−1)-1.

In relation to the cell 204, the inline switch SW(N)-1 has a first terminal and a second terminal. The first terminal of the inline switch SW(N)-1 is connected to the second terminal of the cell 203 and the second terminal of the switch SW(N)-1 is connected to the terminal of the stack 205. In other words, the switch SW(N−1)-1 is in series between the cell 203 and the cell 204. A parallel loop corresponding to cell 204 has a first terminal and a second terminal connected to the stack. In particular, the parallel loop's first terminal is connected to the first terminal of the cell 204, and the parallel loop's second terminal is connected to the inline switch's SW(N)-1 second terminal. On the parallel loop is the outline switch SW(N)-2 that is controlled in an opposite manner to the inline switch SW(N)-1. In other words, when SW(N)-2 is closed, then SW(N)-1 is open; and when SW(N)-2 is open, then SW(N)-1 is closed.

It will be appreciated that each inline switch is placed inline or in series with their corresponding cell, and that each outline switch is placed in parallel with the same corresponding cell and the corresponding inline switch.

It will be appreciated that although four cells are shown in the stack, there may be more cells or less cells within the stack.

In an example aspect, the inline and the outline switches are solid state switches. In another example aspect, the inline and the outline switches are Metal Oxide Semiconductor Field Effect Transistor (MOSFET) switches. In another example aspect, the inline switches and the outline switches are Insulated Gate Bipolar Transistor (IGBT) switches. In another example aspect, the inline switches and the outline switches are Silicon Controlled Rectifier (SCR) switches. In another example aspect, the inline switches and the outline switches are relay switches. It will be appreciated that other types of currently known and future-known switches, including mechanical switches and electrical switches, can be used.

In an example aspect, the corresponding pair of the inline switch and the outline switch behave or operate similar to a double-pole switch that are coupled in operation. In an example embodiment for solid state switches, either electronically or by software control, the operation of the inline switch and the outline switch are coupled together. Generally, if the one of the inline switch and the outline switch is open, then the other one of the inline switch and the outline switch is closed.

As shown in FIG. 2A, the battery control system 206 includes a processor 207, memory 208, and a communication module 209. The memory stores, for example, executable instructions for the processor, which controls the switches. In an example aspect, the executable instructions include different control processes. In another example aspect, the memory also stores current switch states (e.g., open or closed). In a further example aspect, the memory also stores historical switch states, showing the order of the states over time. For example, the switch states are time stamped and stored in memory. In another example aspect, the state of a given cell being connected to the stack 205, or being isolated from the stack 205 is stored in memory. The state of each cell can be stored as a time series (e.g., with time stamps) in memory.

In example applications where the battery control system is part of a larger system, such as a vehicle, or a battery power bank, or the like, the communication module 209 is used to send or receive data, or both. The data can be used to control the batteries, or it can be used to report the battery status, or both. For example, the system includes an external controller 215 that is in data communication with the battery control system 206. In an example aspect, the battery control system 206 and the external controller 215 are in wired data communication with each other, such as using electrical data wiring or fiber optic cables. In another example aspect, the battery control system 206 and the external controller 215 are in wireless data communication with each other. In an example of a vehicle application, the external controller 215 is an electronic control unit (ECU) that communicates with the battery control system 206.

In an example operation, each cell has its own voltage. For example, cell 201 has a voltage Vcell1; cell 202 has a voltage Vcell2; cell 203 has a voltage of Vcell(N−1); and cell 204 has a voltage Vcell(N). The total voltage of the stack is represented by Vstack =Vcell1 +Vcell2 + . . . +Vcell(N−1)+VcellN when all cells in the stack are connected to the stack. The total voltage of the stack can be controlled by maintaining one or more given cells in the stack or isolating one or more given cells in the stack. For example, the total voltage of the stack can be decreased by isolating cell 201, to produce Vstack =Vcell2 + . . . +Vcell(N−1)+VcellN. In other words, the battery control system can dynamically and instantaneously vary the power outputted by the stack by selectively isolating one or more of the cells in the stack.

In the example shown in FIG. 2A, the stack 205 is connected to a load 210, such as an electric motor. However, other types of loads can be attached to the battery stack.

Turning to FIG. 2B, in an alternative example embodiment, the inline switch corresponding to a given cell is positioned in series at the first terminal of the given cell. This configuration is instead of the inline switch being positioned in series at the second terminal of the given cell as shown in FIG. 2A.

FIG. 2C shows another example embodiment with the battery stack 205 connected to a charger 211. More generally, it will be appreciated that the battery stack 205 can be connected to a load or a charger, or both.

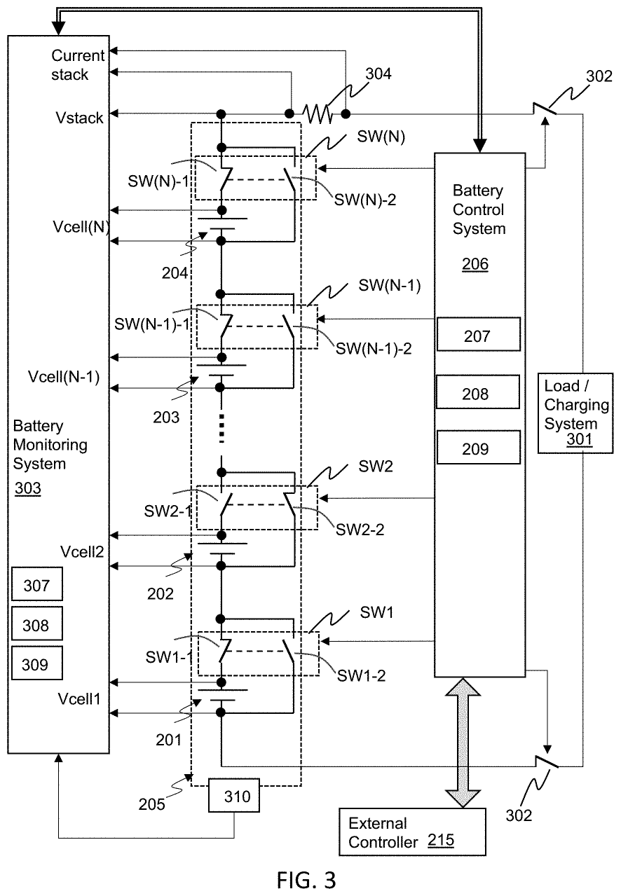

Turning to FIG. 3, another example embodiment is shown of a stack 205 with a battery monitoring system 303. The voltage of each cell is monitored by the battery monitoring system 303, while each cell is connected to the stack 205 and while each cell can be isolated from the stack. In other words, the voltage of a given individual cell can be monitored continuously in both states: during a time when the given cell is isolated from the stack and during a time when the same given cell is electrically connected to the stack.

The entire voltage of the stack (Vstack) is also monitored. In an example aspect, the current of the stack 205 is measured across the resistor 304. It will be appreciated that other devices for measuring current can be used to measure the current of the stack. In another example aspect, the battery monitoring system measures temperature of each cell or the stack. In another example aspect, the battery monitoring system measures chemicals that could be emitted from the cells, such as volatile organic compounds (VOCs) or other chemicals. It will be appreciated that the battery monitoring system may connect to one or more of a variety of different sensors 310 that measure aspects of the cells or the stack 205, or measure the environment of the cells or the stack 205, or a combination thereof. Examples of environmental sensors include: a temperature sensor for measuring temperature; a VOC sensor for measuring VOC concentration; a shock data logger for measuring shocks of vibrations over time; an impact sensor for measuring an impact above a threshold; a strain gauge to measure warping or strain on the body of cells or the battery pack; and, a smoke gas sensor for detecting smoke. In an example aspect, the sensors 310 include multiple sensors of the same type, and each instance of the same sensor is monitoring a given one of the cells. In another example aspect, the sensors 310 include different types of sensors measuring different parameters of the stack. In another example aspect, a given sensor 310 includes an environmental sensor.

The stack is connected to a load system or a charging system, or both, 301. The terminals of the stack are connected to the system 301 via two switches 302 on opposite ends of the battery system. The switches 302 are controlled by the battery control system, for example, to electrically disconnect the battery system from the system 301.

It will be appreciated that the battery monitoring system 303 includes a processor 307, memory 308, and a communication module 309. In an example aspect, the battery monitoring system 303 and the battery control system 206 are in data communication with each other. For example, data about the cells is transmitted from the battery monitoring system to the battery control system, and the battery control system then uses this data to determine which one or more cells to isolate from the stack 205, or to maintain connected to the stack 205.

In another example embodiment, the battery monitoring system 303 and the battery control system 206 is a combined hardware module with the functionality of both monitoring and controlling the cells.

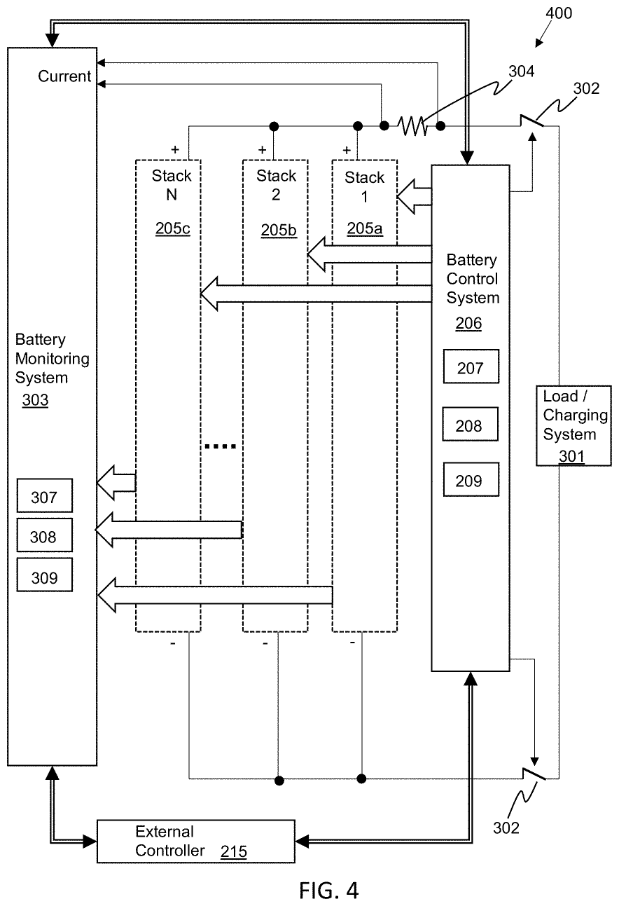

Turning to FIG. 4, an example embodiment 400 is shown of a multiple stacks 205a, 205b, 205c are shown connected in parallel to each other. It will be appreciated that each stack includes cells that can be respectively and independently isolated using pairs of switches, where each pair includes an inline switch and an outline switch. In an example aspect, an ECU is the external controller that is connected to both the battery monitoring system and the battery control system. The example system 400 can be applied to larger systems, including, but not limited to, electric vehicles, power banks or power stations, and robotic platforms.

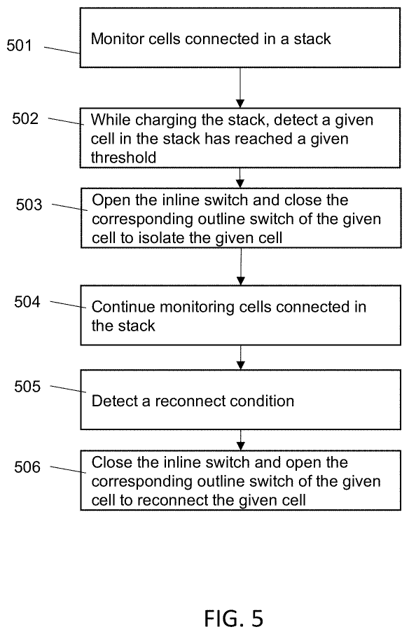

Turning to FIG. 5, example processor executable instructions are provided to control the cells of a stack, while the cells are being charged.

Block 501: The battery control system or the battery monitoring system, or both, monitors cells connected in a stack.

Block 502: The battery control system detects a given cell in the stack has reached or exceeded a given threshold.

For example, the given threshold is that the given cell's charge rate has reached or exceeded a threshold charge rate.

In another example, the given threshold is determined relative to the charge rate of the other cells in the same stack. For example, the given threshold is determined to be greater or equal to the second fastest charge rate of another cell in the same stack. This can be expressed by: threshold charge rate=B+b; where B is the measured charge rate that is the second fastest or second highest of another given cell in the stack, and b is a buffer value. In an example aspect, b is a constant. In another example aspect, b is a value that is derived from B, such as b is a fraction of B. In other words, if a given cell in the stack that is charging too fast, exceeds the comparative computed threshold charge rate, then that given cell is isolated from the stack.

In another example, the given threshold includes a temperature value. For example, if the temperature of the given cell reaches or exceeds a threshold temperature value, then the given cell is isolated from the stack.

In another example, the given threshold includes a VOC value. For example, if the detected concentration of VOC of the given cell reaches or exceeds a threshold VOC concentration level, then the given cell is isolated from the stack.

Other parameters can be measured using sensors to detect problems associated with a given cell being charged too quickly.

Block 503: The battery control system opens the inline switch and closes the corresponding outline switch of the given cell to isolate the given cell.

In an example aspect, the inline switch is opened and the outline switch is closed at the same time.

In another example embodiment, the outline switch is closed first, followed by the opening the inline switch, so that there is no loss of connection along the stack.

Block 504: The battery control system continues monitoring cells connected in the stack.

Block 505: The battery control system detects a reconnection condition.

In an example aspect, a reconnect conditions includes detecting that other cells in he same stack have reached a certain charge threshold.

In an example aspect, a reconnect condition includes detecting that a threshold amount of time has passed since isolating the given cell from the stack.

Other examples of reconnect conditions include: end of charging cycle, disconnecting the charger, changing charge mode (e.g., from fast mode to slow mode or to trickle mode), loss of power, removal of an abnormal status, outside temperature change, and cell charge/voltage level drop.

It will be appreciated that other example conditions can be used to initiate reconnecting the given cell.

Block 506: The battery control system closes the inline switch and opens the corresponding outline switch of the given cell to reconnect the given cell.

In an example aspect, the inline switch is closed and the outline switch is opened at the same time.

In another example embodiment, the inline switch is closed first, followed by the opening the outline switch, so that there is no loss of connection along the stack.

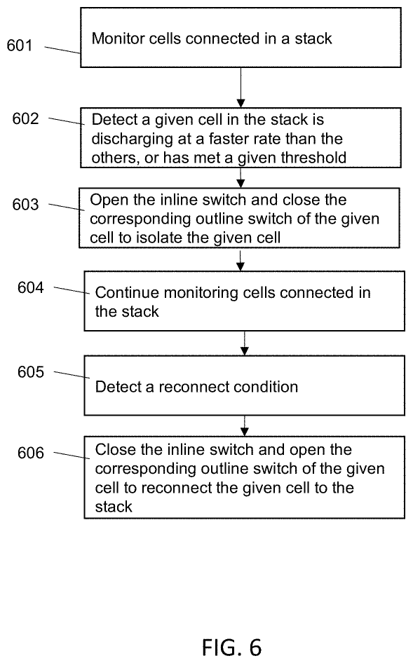

Turning to FIG. 6, example processor executable instructions are provided to control the cells of a stack, while the cells are being discharged, such while power an electrical load.

Block 601: The battery control system or the battery monitoring system, or both, monitors cells connected in a stack.

Block 602: The battery control system detects a given cell in the stack has reached a given threshold or has met some condition.

For example, the given threshold is that the given cell's discharge rate has reached or exceeded a threshold discharge rate.

In another example, the given threshold is determined relative to the charge rate of the other cells in the same stack. For example, the given threshold is determined to be greater or equal to the second fastest discharge rate of another cell in the same stack. This can be expressed by: threshold discharge rate=D+d; where D is the measured discharge rate that is the second fastest or second highest of another given cell in the stack, and d is a buffer value. In an example aspect, d is a constant. In another example aspect, d is a value that is derived from D, such as d is a fraction of D. In other words, if a given cell in the stack that is discharging too fast, exceeds the comparative computed threshold discharge rate, then that given cell is isolated from the stack.

In another example, the given threshold includes a temperature value. For example, if the temperature of the given cell reaches or exceeds a threshold temperature value, then the given cell is isolated from the stack.

In another example, the given threshold includes a VOC value. For example, if the detected concentration of VOC of the given cell reaches or exceeds a threshold VOC concentration level, then the given cell is isolated from the stack.

In another example, the given threshold includes mechanical impact data or pressure data, or both. For example, if an impact is detected or if an increase in pressure is detected,

Other parameters can be measured using sensors to detect problems associated with a given cell being charged too quickly.

In another example, an external controller sends a command to the battery control system, which triggers the battery control system to isolate a given cell from the stack.

Block 603: The battery control system opens the inline switch and closes the corresponding outline switch of the given cell to isolate the given cell.

In an example aspect, the inline switch is opened and the outline switch is closed at the same time.

In another example embodiment, the outline switch is closed first, followed by the opening the inline switch, so that there is no loss of connection along the stack.

Block 604: The battery control system continues monitoring cells connected in the stack.

Block 605: The battery control system detects a reconnection condition.

In an example aspect, a reconnect condition includes detecting that the electrical load has dropped its voltage or current, or both.

In another example aspect, the reconnecting condition includes detecting that the battery or the load, or both, has been put into an idle state.

In another example aspect, the reconnect condition includes detecting that the cell chemistry has recovered and its voltage meets a given threshold.

Other examples of reconnect conditions include: an abnormal condition that is removed or no longer present (e.g., either an abnormal conditions specific to the cell or related to the battery system's ambient environment), emergency demand for power, and entering test or service mode.

It will be appreciated that other example conditions can be used to initiate reconnecting the given cell.

Block 606: The battery control system closes the inline switch and opens the corresponding outline switch of the given cell to reconnect the given cell.

In an example aspect, the inline switch is closed and the outline switch is opened at the same time.

In another example embodiment, the inline switch is closed first, followed by the opening the outline switch, so that there is no loss of connection along the stack.

It will be appreciated that each cell produces electricity based on a chemical reaction in the cell. It is herein recognized that it is advantageous to extend battery life by providing periods of rest to a cell. The periods of rest, in which there is no electrical charging and no discharging, allows the cell chemistry to rebalance itself. By isolating a given cell from the stack, the isolated cell will be able to rest and rebalance its chemistry. In existing passive balancing and active balancing battery circuits, the cells remain part of the stack, which does not allow the cells to rest. However, using the cell balancing system described herein, the pair of switches, which include the inline switch and the outline switch, are used to isolate a given cell from the stack, providing a period of rest for the cell. It will be appreciated that while a given cell from the stack is resting, the other cells in the same stack can be charging or discharging.

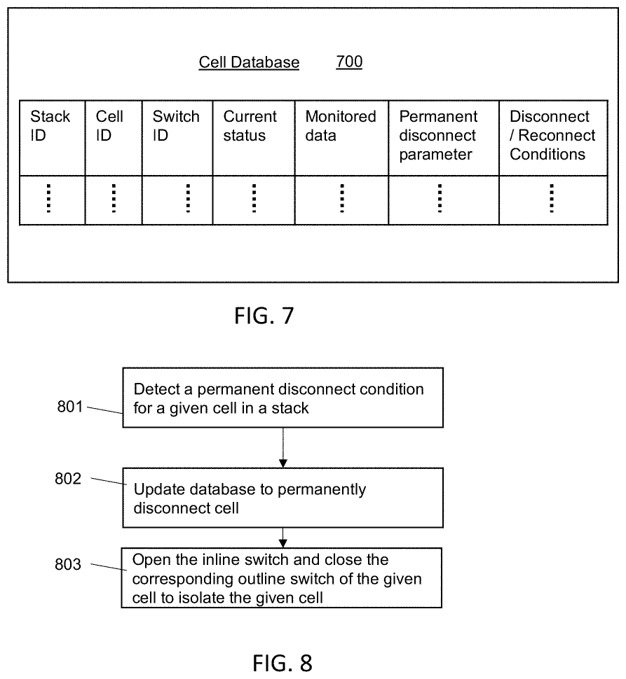

Turning to FIG. 7, an example cell database 700 is provided, which is stored in memory of the battery control system or in memory of the battery monitoring system, or both. The database stores information about each cell. In particular, the database includes a cell identifier (ID), a stack ID, switches IDs, current status, monitored data, a permanent disconnect parameter, and disconnect or reconnect conditions (or both).

For example, each stack is identifiable by a stack ID. Within each stack are multiple cells, which are each identifiable with a cell ID. Each cell is associated with at least a switch pair that includes an inline switch and an outline switch, which are identifiable by switches IDs. For example, the inline switch of a given cell and the outline switch of the same given cell are each identifiable by their own ID.

The current status of a given cell includes the state of the switches (e.g., opened or closed), and whether or not the given cell is connected in series with the stack or isolated from the stack. The status data about the switches also includes a time stamp of when a given inline switch or outline switch, or both, was activated to its current state. For example, the status data specified that a given inline switch is currently closed and it has been closed since a given time, as per a timestamp. In another example, the status data specified that a given outline switch is currently open and it has been opened since a given time, as per a timestamp. The current status of the given cell also includes, for example, voltage data, current data, power, ampere-hours consumed, state of charge, state of health, temperature data, etc.

The monitored data includes a historical time series of the monitored data about a given cell and its respective switches. This includes timestamps indicating when switches were opened and closed, timestamps associated with voltage data, timestamps associated with current data, timestamps associated with temperature data, etc. The time series of monitored data is also used to derive other monitored data of a given cell, such as rate of charging, rate of discharging, minimum voltage level, maximum voltage level, maximum current level, minimum current level, etc. It will be appreciated that the chemistry of the battery changes over time, which could affect the minimum voltage level and the maximum voltage levels detected. The monitored data can be used, for example, to also measure the minimum voltage levels, or the maximum voltage levels, or both, over different times and track the change of minimum levels, or the maximum levels, or both. In another example aspect, the monitored data also includes a time series of data collected by one or more of a variety sensors 310.

The disconnect conditions, or reconnect conditions, or both, include parameters and logic that are used by the processor to determine when to isolate a given cell from a stack, or to connect a given cell to a stack. The logic conditions can be based on meeting threshold values and these values can include one or more of: voltage, current, ampere-hours consumed, state of charge, state of health, temperature, and time. In an example aspect, the logic conditions or threshold values, or both, are derived from historically measured values (e.g., values measured over a time series) or extrapolated values (e.g., future or estimated values computed based on past data), or both. In an example aspect, the threshold values are based on data measured with respect to one or more of: the cell, the stack, the charger, and the load.

Turning to FIG. 8, an example embodiment of executable instructions is provided for permanently isolating a cell from a stack. For example, a stack contains many cells and it is herein recognized that a damaged cell within the stack could degrade the overall performance and lifetime of the stack. Therefore, it is herein recognized that there are situations when it is desirable to permanently isolate a cell, such as a damaged cell, from the stack. Doing so will mitigate the negative effects caused by a damaged cell to the overall stack. It will be appreciated that there may be other reasons to permanently or semi-permanently isolate a cell from a stack. After a given cell has been permanently or semi-permanently isolated from the stack, it can be electrically connected back to the stack after being serviced or replaced.

Block 801: The battery control system detects a permanent or semi-permanent disconnect condition for a given cell in a stack.

In an example aspect, the condition includes detecting from the monitored data that the given cell is repeatedly or consistently underperforming in charging or discharging, or both, as per given a charge threshold parameter or a discharge threshold parameter, or both.

In another example aspect, the condition includes detecting that the given cell's temperature is too high, as per a given temperature threshold parameter.

In another example aspect, the condition includes detecting that the rate of discharge is too quick or too slow for the given cell. In another example aspect, the condition includes detecting that the rate of charge is too quick or too slow for the given cell. This condition, for example, includes one or more given rate of charge threshold parameters, or one or more rate of discharge threshold parameters.

In another example aspect, the condition includes detecting that the maximum voltage of the cell is below an expected threshold voltage, also another threshold parameter.

It will be appreciated that other different conditions for permanently or semi-permanently disconnecting a cell from a stack are applicable to the principles described herein.

Block 802: The battery control system updates the database to permanently disconnect or isolate the given cell from the stack.

Block 803: The battery control system also opens the inline switch and closes the corresponding outline switch of the given cell, thereby isolating the given cell.

By updating the database, the battery control system knows not to reconnect the cell to the stack. It also provides awareness to other power systems and to technicians about the permanent isolation status of the given cell, including the resulting or new total power storage capability of the battery system. In particular, when a cell is permanently removed from the stack, the total voltage output and the total energy storage capability of the stack is reduced.

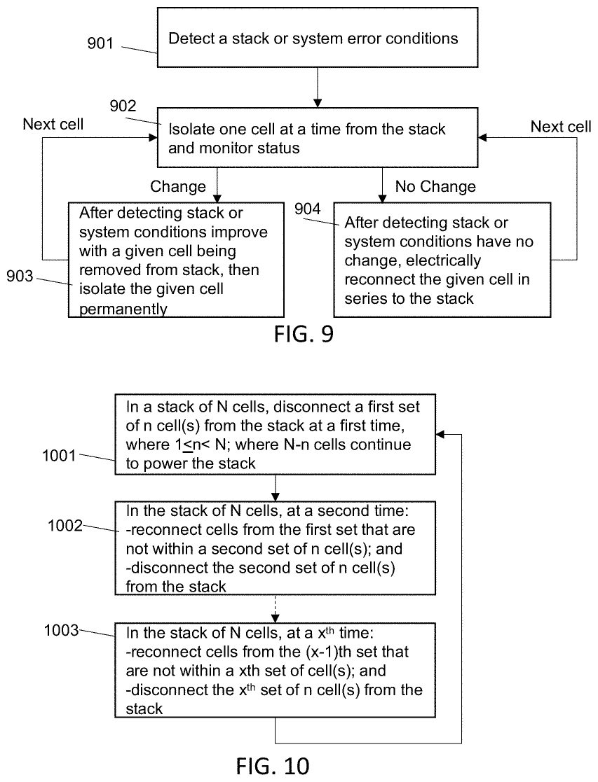

Turning to FIG. 9, an example embodiment of executable instructions is provided for testing cells to determine the cause of a system problem. In particular, it is herein recognized that sensors are expensive and, it is not cost feasible or technically feasible to have a suite of sensors dedicated to measuring each cell individually. Instead, it is more typical in practice to have one or more sensors measure one or more aspects of a stack as a whole, or to measure one or more aspects of a battery system as a whole. For example, one or a few pressure sensors are positioned on or around a stack or a battery system to determine if any impact has been made on the batteries. In another example, a smoke or particulate sensor is positioned on or around a stack or a battery system to determine if any of the batteries are off-gassing. In another example, one or more temperature sensors are positioned on or around a stack to determine the overall temperature of a stack or a battery system. In another example, a stack cannot deliver required power to the load due to a weak cell in the stack.

These sensors can determine a measurement of a stack or overall system, but the particular cell or cells that cause a detected problem cannot be identified. It is herein recognized that the battery control system and circuit described herein can be advantageously used to isolate one or more cells and test to determine if a given cell is the cause of a condition detected of the stack or of the overall system. A process for executing a rolling test of cells in a stack is provided below.

Block 901: The battery control system or battery monitoring system, or both, detects an error condition in a stack or the overall battery system.

For example, smoke is detected; a temperature above a certain threshold is detected; particles above a certain concentration are detected; chemicals, such as VOCs, above a certain concentration are detected; or, a force, or pressure, or impact above a threshold is detected; or a combination thereof. These can be measured by a sensor or sensors 310. In another example, the error condition relates to a rate of charge or rate of discharge. In another example, the error condition relates to a state of health or state of charge, or both. In another example, the error condition is detected by an external controller and it sends the error message to the battery control system. It will be appreciated that other error conditions can be detected.

Block 902: The battery control system electrically isolates one cell at a time from the stack and monitors the status of the stack or the overall battery system, or both. For example, a given cell is isolated by opening the inline switch and closing the outline switch associated with the given cell. While the given cell is isolated, measurements of the stack or the overall battery system are taken to determine if there is a change in the condition. For example, the test while the given cell is isolated is run for a given period of time.

While the given cell is isolated, if there is no change in the measurements, then the given cell is considered to have no effect on the error condition. See block 904.

While the given cell is isolated, if there is a change in the measurements, then the given cell is flagged in the battery control system to be contributing to the error condition. See block 903.

Block 903: After detecting the stack or system conditions change with a given cell being removed from stack, the battery control system isolates the given cell permanently. The process of isolating the given cell permanently, for example, is described with respect to FIG. 8.

Block 904: After detecting stack or system conditions have no change, the battery control system electrically reconnects the given cell in series to the stack. In particular, the inline switch is closed and the outline switch is opened.

It will be appreciated that after the period of time for running the test has passed and the determination of the given cell, the process is repeated for another cell in the stack. In this way, the cell or the cells that contribute to the error condition are removed from the stack, while the remain cell or the remaining cells continue to be connected to form the stack and power the system.

This system and process improves the self-diagnostic capabilities of the battery system and improves the safety capabilities of the battery system.

Turning to FIG. 10, an example embodiment is provided for a battery control system providing rest periods to cells in a stack using the battery circuit described herein. It is herein recognized that each cell's chemistry can become unbalanced due to charging and discharging, and that by providing a period of rest, the cell's chemistry will rebalance itself. Using the battery circuit described herein, a given cell can be electrically isolated from the stack, during which time the given cell can rest.

One or more cells in a stack, for example, can be electrically isolated for periods of time from a stack. This will improve the overall performance of each cell and the lifetime functionality of the cell.

The example process described below selectively isolates a subset of the cells of the stack at different times, so that the stack can continuously provide power to a load or can continuously be charged, even while a subset of the cells is being isolated for rest. In other words, the battery control system executes a rolling process to isolate some of the cells at a time.

Block 1001: In a stack of N cells, the battery control system disconnects or isolates a first set of n cell(s) from the stack at a first time, where 1≤n<N and where N-n cells continue to power the stack.

Block 1002: In the stack of N cells, at a second time (e.g., at a time after the first time), the battery control system reconnects any cell(s) from the first set that are not part of a second set of n cell(s), and disconnects the second set of n cell(s) from the stack.

In an example aspect, the reconnection of the cell(s) from the first set occurs at the same time as disconnecting the second set of n cell(s). In another example aspect, the cell(s) from the first set are reconnected first and then the second set of n cell(s) are disconnected from the stack.

In an example aspect, all the cells of the second set are different cells from the first set. In an alternative example aspect, one or more of the cells for the second are also part of the first set of cells, herein called “overlapping cells”, and these overlapping cells remain disconnected from the stack when transitioning from isolating the first set to isolating the second set.

Block 1003: In the stack of N cells, at a x^{th} time, the battery control system reconnects cells from the (x-1)^{th} set that are not within a x^{th} set of cell(s), and disconnects the x^{th} set of n cell(s) from the stack, where x is a natural number and 2≤x≤S. S is the total number of sets of cells in a stack.

In an example aspect, the reconnection of the cell(s) from the (x-1)^{th} set occurs at the same time as disconnecting the x^{th} set of n cell(s). In another example aspect, the cell(s) from the (x-1)^{th} set are reconnected first and then the x^{th} set of n cell(s) are disconnected from the stack.

In a preferred example, the reconnection and disconnection of different cells is done in a way to provide a steady voltage value across the battery stack.

In a preferred example embodiment, the number of sets of cells S in a stack is equal to or less than the total the number of cells N in a stack. In another example embodiment, S>N. It will be appreciated that the number of cells within each set can be the same, or, in another example, the number of cells can vary amongst the sets. It will also be appreciated that each set of cells can includes one or more cells that are designated in another set, also herein called “overlapping cells”. For example, a first set of cells includes CELL1 and CELL2, and a second set of cells includes CELL2 and CELL3. In this example, CELL2 is an overlapping cell between the first set and the second set.

In another example aspect, the time difference between switching sets is constant. For example, a first subset of cells in the stack is isolated for a set length of time; a second subset of cells in the stack is isolate for the same set length of time; and so forth. Alternatively, the isolation period, or rest period varies between different subsets of cells. The length of time for isolation or rest, for example, is variable and depends on other conditions. Example conditions include the state of charge, the voltage, the temperature, ampere-hours consumed to date, etc. In another example aspect, an isolated cell which is resting, is monitored by the battery control system or the battery monitoring system, and when the cell's health (e.g. voltage, state of charge, temperature, etc.) is detected to reach a nominal threshold, then the isolated cell is connected back to the stack.

In an example embodiment, a stack includes ten cells (e.g., CELL1, CELL2, CELL3, . . . , CELL10). At a first time, CELL1 is isolated from the stack, and CELL2 to CELL10 are connected to the stack. At a second time, CELL2 is isolated, and the remaining nine cells are connected to the stack. At a third time, CELL3 is isolated, and the remaining nine cells are connected to the stack. This process continues until CELL10 is isolated, and the remaining nine cells are connected. After, the process repeats by isolating CELL1 again, while the remining nine cells are connected to the stack. In this example, there is a duty cycle of 90% of the stack being operational for powering a load or for charging. For additional context, a 100% duty cycle herein means that all the cells in the stack are electrically connected in series.

In another example embodiment, a stack includes ten cells (e.g., CELL1, CELL2, CELL3, . . . , CELL10). At a first time, CELL1 and CELL2 are isolated from the stack, and the remaining eights cells are connected to the stack. At a second time, CELL2 and CELL3 are isolated, and the remaining eight cells are connected to the stack. At a third time, CELL3 and CELL4 are isolated, and the remaining eight cells are connected to the stack. This process continues until CELL9 and CELL10 isolated, and then finally until CELL10 and CELL1 are isolated, while the remaining eight cells are connected. After, the process repeats by isolating CELL1 and CELL2 again, while the remining eight cells are connected to the stack. In this example, there is a duty cycle of 80% of the stack being operational for powering a load or for charging.

It will be appreciated that the battery control system can vary the parameters of the number of cells being at rest to vary the amount of power being provided. For example, the battery control system can dynamically adjust the duty cycle (e.g., 90%, 80%, 70%, etc.), thereby dynamically adjusting the power output of the stack.

Using the above process and system, each of the cells are provided a period of rest, while still continuously maintaining operation by the remaining cells connected to the stack.

It will be appreciated that the use of inline and outline switches is very fast can be used to instantly isolate a cell from a stack, or electrically connect a cell back to the stack. In this way, the battery circuit described herein supports fast charging and very fast balancing. The battery circuit described herein also supports very fast dynamic power adjustment, as the cells can be instantly isolated and reconnected to a stack. By contrast, bleeding energy through a resistor, or redistributing energy through a capacitor or inductor or transformer, is slower.

It will also be appreciated that the circuitry described herein can reduce, or even eliminate a single cell's weakness on affecting the overall stack. For example, the negative influence of a weak cell is removed from a stack by permanently isolating the weak cell. This increases the length of the lifetime functionality of the overall stack. By contrast, in other balancing circuits that keep the weak cells or damaged cells connected to the stack, even while power is shunted or redistributed, the weak cells or damaged cells still affect the overall stack.

The battery circuitry described herein also facilitates periodic rest of any one or more given cells in a stack, while still having other remaining cells provide power or receive a charge. The use ability to provide rest to the cells will increase the length of the lifetime functionality of the cells. By contrast, in other balancing circuits that keep cells connected to the stack, there is no rest for the cells to rebalance their chemistry.

In another example embodiment, the control circuitry using the inline switches and the outline switches is also applied to controlling fuel cells that are electrically connected to form a stack.

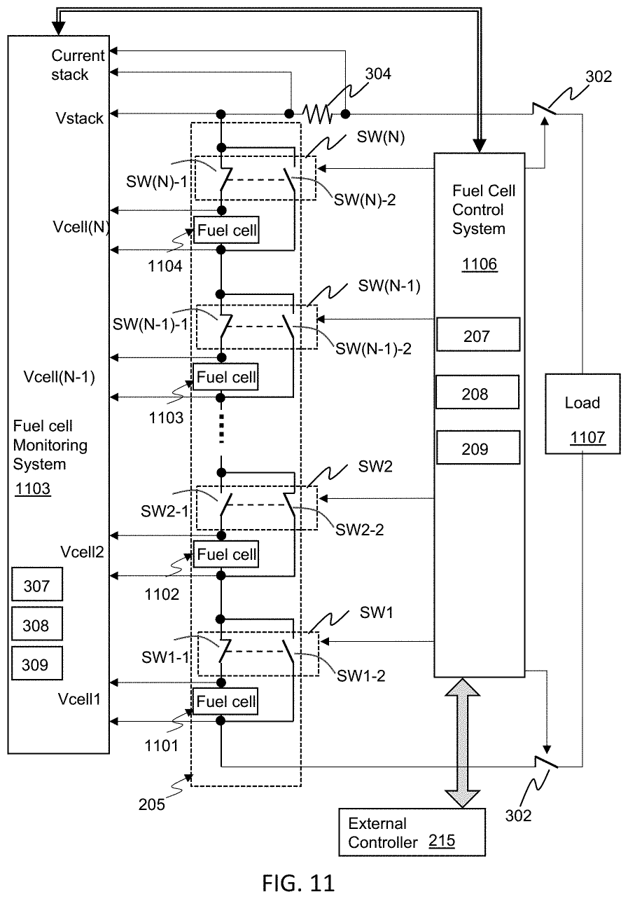

Turning to FIG. 11, an example embodiment of fuel cells 1101, 1102, 1103, 1104 are connected in series to form a stack 205. Each given fuel cell in the stack is connected in series to a respective inline switch, and a respective outline switch is connected in parallel to both the respective inline switch the given fuel cell. A fuel cell control system 1106 control the switches to electrically isolate a given fuel cell from the stack 205, or to electrically reconnect the given fuel cell to the stack. A fuel cell monitoring system 1103 monitors each fuel cell. The electrical energy from the stack of fuel cells is used to power a load 1107, such as driving an electric motor or some other load. The fuel cell system shown in FIG. 11, for example, is used to drive a vehicle, such as a land transport vehicle, a heavy machinery vehicle, or a marine vessel, or a submarine vessel. It will be appreciated that the control processes described herein with respect to battery control for the switches can also be used to control the inline switches and the outline switches of the fuel cell stack.

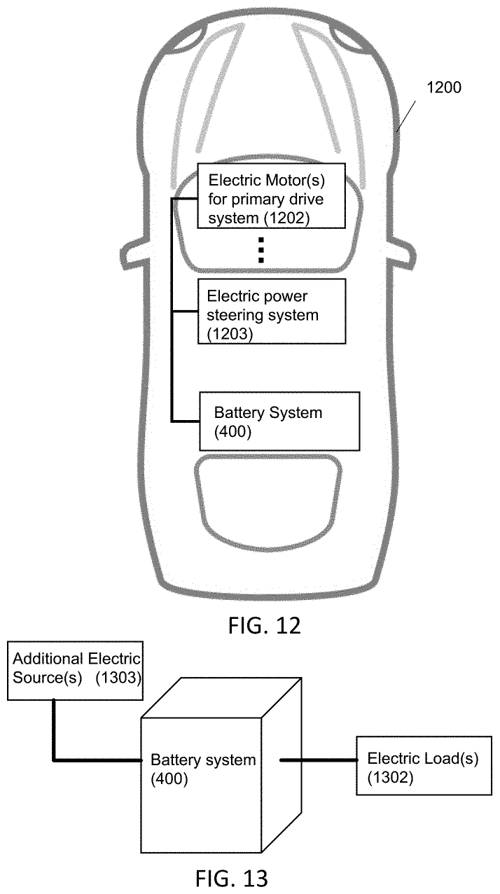

FIG. 12 shows an example embodiment of a vehicle 1200 that includes a battery cell system or a fuel cell system 400. For example, multiple stacks of energy cells (e.g. battery cells or fuel cells) are included in the vehicle and that are part of the battery system 400. The battery system 400 provides electric power to different subsystems in the vehicle, including, for example, one or more electric motors for the primary drive system 1202 and the electric power steering system 1203. One or more ECUs are part of the subsystems of the vehicle, which control and coordinate the subsystems. Although the vehicle 1200 is shown as a car, it will be appreciated that other types of vehicles (e.g., trucks, construction vehicles, buses, transport vehicles, aircraft, drones, boats, submarines, trains, etc.) can include the battery system 400. Instead of a battery system, it will be appreciated that the fuel cell system shown in FIG. 11 can be used to power the vehicle.

FIG. 13 shows an example embodiment of a battery system 400 providing electric power to one or more electric loads 1302. For example, the battery system 400 is part of a power supply unit that includes one or more types of electric energy sources. This power supply unit can be setup, for example, in remote locations. In another example, this power supply unit can also be as a localized power bank, such as for a building or equipment, or both. In another example, this power supply unit and the one or more loads 1302 are part of a machine. In another example, an additional electric source 1303 (e.g., additional electric generator, additional wind turbine, additional solar cells, etc.) supplies electric power to the mobile power supply unit's battery system 400. In an example embodiment, the power supply unit is mobile so that it can be transported. In another example embodiment, the power supply unit is stationary.

It will be appreciated that the principles of the battery balancing system described herein can be applied to different machines and devices that use electric energy.

Below are example embodiments of the battery system described herein.

In an example embodiment, a battery control circuit comprises: a first battery cell and a second battery cell connected in series to form a battery stack;

a first inline switch connected in series with the first battery cell, and a first outline switch connected in parallel to the first battery cell and the first inline switch;

a second inline switch connected in series with the second battery cell, and a second outline switch connected in parallel to the second battery cell and the second outline switch; and

a battery control system to control the first inline switch, the first outline switch, the second inline switch, and the second outline switch.

In an example aspect, the battery control circuit is configured to control one of the first inline switch and the first outline switch to be open, and, at a same time, control an other one of the first inline switch and the first outline to be closed.

In an example aspect, the battery control circuit is configured to control the first inline switch to be open and the first outline switch to be closed to electrically isolate the first cell from the battery stack.

In an example aspect, the first inline switch is opened, and the first outline switch is closed at a same time.

In an example aspect, the first outline switch is closed first and then the first inline switch is opened.

In an example aspect, the first cell is electrically isolated from the battery stack, and the battery control circuit is configured to control the first inline switch to be closed and the first outline switch to be open to electrically reconnect the first cell in series with the battery stack.

In an example aspect, the first battery cell is monitored while electrically isolated from the battery stack, and while electrically connected to the battery stack.

In an example aspect, the first battery cell is electrically isolated from the battery stack by controlling the first inline switch to be open and the first outline switch to be closed; the second battery cell is electrically isolated from the battery stack by controlling the second inline switch to be open and the second outline switch to be closed; and, the first battery cell and the second battery cell are isolated from the battery stack at different times from each other.

In an example aspect, the battery control system comprises a processor and memory, and the memory stores executable instructions to electrically isolate a given battery cell in the battery stack according to one or more threshold conditions.

In an example aspect, the one or more threshold conditions comprise, after detecting a voltage of the given battery cell has reached a voltage threshold, electrically isolating the given battery cell.

In an example aspect, the one or more threshold conditions comprise, after detecting the given battery cell has been electrically connected to the battery stack for a threshold amount of time, electrically isolating the given battery cell.

In an example aspect, the one or more threshold conditions comprise, after detecting the given battery cell has temperature at a threshold temperature, electrically isolating the given battery cell.

In an example aspect, the one or more threshold conditions comprise, after detecting a rate of charge of the given battery has reached a rate of charge threshold, electrically isolating the given battery cell.

In an example aspect, the battery control system comprises a processor and memory, and the memory stores executable instructions to electrically reconnect a given battery cell in the stack according to one or more threshold conditions.

In an example aspect, the battery control system comprises a processor and memory, and the memory stores thereon at least a cell database comprising cell identifiers for each cell, and switch identifiers for each switch, and an associated status for each cell indicating whether or not a given cell is permanently isolated from the battery stack; and, wherein a given cell that is permanently isolated from the battery stack has its respective inline switch permanently opened and its respective outline switch permanently closed.

In an example aspect, the battery control system comprises a processor and memory, and the memory stores thereon at least processor executable instructions that comprise: detecting or receiving an error condition of the battery stack; electrically isolating one given battery cell at a time in the battery stack by opening the given battery cell's respective inline switch and closing the given battery cell's respective outline switch; and, after detecting or receiving the same error condition of the battery pack while the one given battery cell is electrically isolated, then electrically reconnecting the given battery cell to the battery stack by closing the given battery cell's respective inline switch and opening the given battery cell's respective outline switch.

In an example aspect, the battery control system comprises a processor and memory, and the memory stores thereon at least processor executable instructions that comprise: detecting or receiving an error condition of the battery stack; electrically isolating one given battery cell at a time in the battery stack by opening the given battery cell's respective inline switch and closing the given battery cell's respective outline switch; and, after detecting that the error condition has changed while the one given battery cell is electrically isolated, then permanently or semi-permanently keeping the one given battery cell electrically isolated from the battery stack.

In an example embodiment, a battery control circuit comprises:

battery cells connected in series to form a battery stack;

each respective battery cell in the battery stack is connected in series with a respective inline switch, and a respective outline switch is connected in parallel to both the respective battery cell and the respective inline switch; and

a battery control system to control each of the respective inline switches and the respective outline switches.

In an example aspect, the battery control circuit is configured to electrically isolate a given battery cell from the battery stack by opening the respective inline switch of the given battery cell and closing the respective outline switch of the given battery cell.

In an example aspect, at a same time, the respective inline switch of the given battery cell is opened and the respective outline switch of the given battery cell is closed.

In an example aspect, the respective outline switch of the given battery cell is closed first and then the respective inline switch of the given battery cell is opened.

In an example aspect, the battery control circuit is configured to reconnect a given battery cell that is electrically isolated from the battery stack by closing the respective inline switch of the given battery cell and opening the respective outline switch of the given battery cell.

In an example embodiment, a battery system comprises:

battery stacks electrically connected in parallel with each other;

each one of the battery stacks comprising:
battery cells electrically connected in series to from a given battery stack;
each respective battery cell in the given battery stack is connected in series with a respective inline switch, and a respective outline switch is connected in parallel to both the respective battery cell and the respective inline switch; and
a battery control system to control each of the respective inline switches and the respective outline switches.

In an example aspect, a given battery cell in the battery system is electrically isolated from its respective battery stack by opening the given battery cell's respective inline switch and closing the given battery cell's respective outline switch.

In an example aspect, a given battery cell in the battery system is electrically isolated from its respective battery stack, and the given battery cell is electrically reconnected in series to its respective battery stack by closing the given battery cell's respective inline switch and opening the given battery cell's respective outline switch.

In an example embodiment, a fuel cell system comprises:
fuel cells electrically connected in series to form a fuel cell stack;
each respective fuel cell in the fuel stack is connected in series with a respective inline switch, and a respective outline switch is connected in parallel to both the respective fuel cell and the respective inline switch; and
a fuel cell control system to control each of the respective inline switches and the respective outline switches.

In an example aspect, the fuel cell control circuit is configured to electrically isolate a given fuel cell from the fuel cell stack by opening the respective inline switch of the given fuel cell and closing the respective outline switch of the given fuel cell.

In an example aspect, at a same time, the respective inline switch of the given fuel cell is opened and the respective outline switch of the given fuel cell is closed.

In an example aspect, the respective outline switch of the given fuel cell is closed first and then the respective inline switch of the given fuel cell is opened.

In an example aspect, the fuel cell control circuit is configured to reconnect a given fuel cell that is electrically isolated from the fuel cell stack by closing the respective inline switch of the given fuel cell and opening the respective outline switch of the given fuel cell.

In an example embodiment, a battery system comprises:

battery cells connected in series to form a battery stack;

each respective battery cell in the battery stack is connected in series with a respective inline switch, and a respective outline switch is connected in parallel to both the respective battery cell and the respective inline switch;

a battery control system to control each of the respective inline switches and the respective outline switches, and a given cell is electrically isolated from the battery stack by opening the given cell's respective inline switch and closing the given cell's outline switch;

wherein at a first time, the battery control system electrically isolates a first subset of one or more battery cells from the battery stack; and

wherein at a second time, the battery control system electrically reconnects the first subset of the one or more battery cells to the battery stack, and electrically isolates a second subset of one or more battery cells from the battery stack.

It will be appreciated that any module or component exemplified herein that executes instructions may include or otherwise have access to non-transitory computer readable media such as storage media, computer storage media, or data storage devices (removable and/or non-removable) such as, for example, memory chips, magnetic disks, optical disks. Computer storage media may include volatile and non-volatile, removable and non-removable media implemented in any method or technology for storage of information, such as computer readable instructions, code, processor executable instructions, data structures, program modules, or other data. Examples of computer storage media include random access memory (RAM), dynamic random access memory (DRAM), static random access memory (SRAM), read-only memory (ROM), solid-state ROM, electrically erasable programmable read-only memory (EEPROM), flash memory or other memory technology, or any other medium which can be used to store the desired information and which can be accessed by an application, module, or both. Any such computer storage media may be part of the servers or computing devices, or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A battery control circuit comprising:
a first battery cell and a second battery cell connected in series to form a battery stack;
a first inline switch connected in series with the first battery cell, and a first outline switch connected in parallel to the first battery cell and the first inline switch;
a second inline switch connected in series with the second battery cell, and a second outline switch connected in parallel to the second battery cell and the second outline switch; and
a battery control system to control the first inline switch, the first outline switch, the second inline switch, and the second outline switch.

2. The battery control circuit of claim 1 wherein the battery control circuit is configured to control one of the first inline switch and the first outline switch to be open, and, at a same time, control an other one of the first inline switch and the first outline to be closed.

3. The battery control circuit of claim 1 wherein the battery control circuit is configured to control the first inline switch to be open and the first outline switch to be closed to electrically isolate the first cell from the battery stack.

4. The battery control circuit of claim 3 wherein the first inline switch is opened and the first outline switch is closed at a same time.

5. The battery control circuit of claim 3 wherein the first outline switch is closed first and then the first inline switch is opened.

6. The battery control circuit of claim 1 wherein the first cell is electrically isolated from the battery stack, and the battery control circuit is configured to control the first inline switch to be closed and the first outline switch to be open to electrically reconnect the first cell in series with the battery stack.

7. The battery control circuit of claim 1 wherein the first battery cell is monitored while electrically isolated from the battery stack, and while electrically connected to the battery stack.

8. The battery control circuit of claim 1 wherein the first battery cell is electrically isolated from the battery stack by controlling the first inline switch to be open and the first outline switch to be closed; the second battery cell is electrically isolated from the battery stack by controlling the second inline switch to be open and the second outline switch to be closed; and, the first battery cell and the second battery cell are isolated from the battery stack at different times from each other.

9. The battery control circuit of claim 1 wherein the battery control system comprises a processor and memory, and the memory stores executable instructions to electrically isolate a given battery cell in the battery stack according to one or more threshold conditions.

10. The battery control circuit of claim 9 wherein the one or more threshold conditions comprise, after detecting a voltage of the given battery cell has reached a voltage threshold, electrically isolating the given battery cell.

11. The battery control circuit of claim 9 wherein the one or more threshold conditions comprise, after detecting the given battery cell has been electrically connected to the battery stack for a threshold amount of time, electrically isolating the given battery cell.

12. The battery control circuit of claim 9 wherein the one or more threshold conditions comprise, after detecting the given battery cell has temperature at a threshold temperature, electrically isolating the given battery cell.

13. The battery control circuit of claim 9 wherein the one or more threshold conditions comprise, after detecting a rate of charge of the given battery has reached a rate of charge threshold, electrically isolating the given battery cell.

14. The battery control circuit of claim 1 wherein the battery control system comprises a processor and memory, and the memory stores executable instructions to electrically reconnect a given battery cell in the stack according to one or more threshold conditions.

15. The battery control circuit of claim 1 wherein the battery control system comprises a processor and memory, and the memory stores thereon at least a cell database comprising cell identifiers for each cell, and switch identifiers for each switch, and an associated status for each cell indicating whether or not a given cell is permanently isolated from the battery stack; and, wherein a given cell that is permanently isolated from the battery stack has its respective inline switch permanently opened and its respective outline switch permanently closed.

16. The battery control circuit of claim 1 wherein the battery control system comprises a processor and memory, and the memory stores thereon at least processor executable instructions that comprise: detecting or receiving an error condition of the battery stack; electrically isolating one given battery cell at a time in the battery stack by opening the given battery cell's respective inline switch and closing the given battery cell's respective outline switch; and, after detecting or receiving the same error condition of the battery pack while the one given battery cell is electrically isolated, then electrically reconnecting the given battery cell to the battery stack by closing the given battery cell's respective inline switch and opening the given battery cell's respective outline switch.

17. The battery control circuit of claim 1 wherein the battery control system comprises a processor and memory, and the memory stores thereon at least processor executable instructions that comprise: detecting or receiving an error condition of the battery stack; electrically isolating one given battery cell at a time in the battery stack by opening the given battery cell's respective inline switch and closing the given battery cell's respective outline switch; and, after detecting that the error condition has changed while the one given battery cell is electrically isolated, then permanently or semi-permanently keeping the one given battery cell electrically isolated from the battery stack.

18. A battery control circuit comprising:
battery cells connected in series to form a battery stack;
each respective battery cell in the battery stack is connected in series with a respective inline switch, and a respective outline switch is connected in parallel to both the respective battery cell and the respective inline switch; and
a battery control system to control each of the respective inline switches and the respective outline switches.

19. The battery control circuit of claim 18 wherein the battery control circuit is configured to electrically isolate a given battery cell from the battery stack by opening the respective inline switch of the given battery cell and closing the respective outline switch of the given battery cell.

20. The battery control circuit of claim 19 wherein, at a same time, the respective inline switch of the given battery cell is opened and the respective outline switch of the given battery cell is closed.

21. The battery control circuit of claim 19 wherein the respective outline switch of the given battery cell is closed first and then the respective inline switch of the given battery cell is opened.

22. The battery control circuit of claim 18 wherein the battery control circuit is configured to reconnect a given battery cell that is electrically isolated from the battery stack by closing the respective inline switch of the given battery cell and opening the respective outline switch of the given battery cell.

23. A battery system comprising:
battery stacks electrically connected in parallel with each other;
each one of the battery stacks comprising:
battery cells electrically connected in series to from a given battery stack;
each respective battery cell in the given battery stack is connected in series with a respective inline switch, and a respective outline switch is connected in parallel to both the respective battery cell and the respective inline switch; and
a battery control system to control each of the respective inline switches and the respective outline switches.

24. The battery system of claim 23 wherein a given battery cell in the battery system is electrically isolated from its respective battery stack by opening the given battery cell's respective inline switch and closing the given battery cell's respective outline switch.

25. The battery system of claim 23 wherein a given battery cell in the battery system is electrically isolated from its respective battery stack, and the given battery cell is electrically reconnected in series to its respective battery stack by closing the given battery cell's respective inline switch and opening the given battery cell's respective outline switch.

26. A fuel cell system comprising:
fuel cells electrically connected in series to form a fuel cell stack;
each respective fuel cell in the fuel stack is connected in series with a respective inline switch, and a respective outline switch is connected in parallel to both the respective fuel cell and the respective inline switch; and
a fuel cell control system to control each of the respective inline switches and the respective outline switches.

27. The fuel cell system of claim 26 wherein the fuel cell control circuit is configured to electrically isolate a given fuel cell from the fuel cell stack by opening the respective inline switch of the given fuel cell and closing the respective outline switch of the given fuel cell.

28. The fuel cell system of claim 27 wherein, at a same time, the respective inline switch of the given fuel cell is opened and the respective outline switch of the given fuel cell is closed.

29. The fuel cell system of claim 27 wherein the respective outline switch of the given fuel cell is closed first and then the respective inline switch of the given fuel cell is opened.

30. The fuel cell system of claim 26 wherein the fuel cell control circuit is configured to reconnect a given fuel cell that is electrically isolated from the fuel cell stack by closing the respective inline switch of the given fuel cell and opening the respective outline switch of the given fuel cell.

31. A battery system comprising:
battery cells connected in series to form a battery stack;
each respective battery cell in the battery stack is connected in series with a respective inline switch, and a respective outline switch is connected in parallel to both the respective battery cell and the respective inline switch;
a battery control system to control each of the respective inline switches and the respective outline switches, and a given cell is electrically isolated from the battery stack by opening the given cell's respective inline switch and closing the given cell's outline switch;
wherein at a first time, the battery control system electrically isolates a first subset of one or more battery cells from the battery stack; and
wherein at a second time, the battery control system electrically reconnects the first subset of the one or more battery cells to the battery stack, and electrically isolates a second subset of one or more battery cells from the battery stack.

32. The battery system of claim 31 wherein there are N number of subsets of one or more battery cells in the battery stack, the N number of subsets including the first subset and the second subset, and one of the N number subsets is isolated at a time.
